(19) United States
(12) Patent Application Publication
(10) Pub. No.: US 2024/0418029 A1
(43) Pub. Date: Dec. 19, 2024

(54) Removable Window Panel Device

(71) Applicant: Richard Conybear, Littleton, CO (US)

(72) Inventor: Richard Conybear, Littleton, CO (US)

(21) Appl. No.: 18/211,545

(22) Filed: Jun. 19, 2023

(51) Int. Cl. E06B 3/06

(52) U.S. Cl. CPC E06B 3/06

(57) ABSTRACT

A removable window panel device includes a surround that is structured to have dimensions which conform to a window screen opening in a window frame. A panel is integrated into the surround and the panel is comprised of a fluid impermeable material to inhibit wind from passing through the panel. Each tension spring of a pair of tension springs is each attached to the surround and each tension spring is compressible to lie flat against the surround when the surround is inserted into the window screen opening in the window frame. Each of the pair of tension springs is biased to curve upwardly from the surround to retain the surround in the window screen opening, A pair of tabs is coupled to the surround for gripping to install the surround in the window screen opening.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to window panel devices and more particularly pertains to a new window panel device for enhancing the thermal efficiency of a double pane window. The device includes a windowpane and a surround extending around the windowpane that can be installed in the window screen opening of a window frame. In this way the windowpane replaces the window screen thereby inhibiting wind from passing through the window screen opening in the window frame.

### (2) Description of Related Art Including Information Disclosed Under 37 CFR 1.97 and 1.98

The prior art relates to window panel devices including a variety of thermal inserts for window frames that includes a thermally insulating blanket that is positioned in a window frame and a variety of modular windowpane inserts for attaching an additional windowpane to a window frame. In no instance does the prior art discloses a windowpane and casement that is structured to integrate into a window screen opening of a window frame for enhancing the thermal efficiency of a double pane window.

### BRIEF SUMMARY OF THE INVENTION

An embodiment of the disclosure meets the needs presented above by generally comprising a surround that is structured to have dimensions which conform to a window screen opening in a window frame. A windowpane is integrated into the surround and the windowpane is comprised of a fluid impermeable material to inhibit wind from passing through the windowpane. A pair of tension springs is each attached to the surround and each of the tension springs is compressible to lie flat against the surround when the surround is inserted into the window screen opening in the window frame. Each of the pair of tension springs is biased to curve upwardly from the surround to retain the surround in the window screen opening. A pair of tabs is coupled to the surround for gripping to install the surround in the window screen opening.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a removable window panel device according to an embodiment of the disclosure.

FIG. 2 is a front view of an embodiment of the disclosure.

FIG. 3 is a magnified detail view taken from circle 3 of FIG. 2 of an embodiment of the disclosure.

FIG. 4 is a left side view of an embodiment of the disclosure.

FIG. 5 is a top view of an embodiment of the disclosure.

FIG. 6 is a front view of an alternative embodiment of the disclosure.

FIG. 7 is a cross sectional view taken along line 7-7 of FIG. 6 of an embodiment of the disclosure.

FIG. 8 is an exploded in-use view of an embodiment of the disclosure.

### DETAILED DESCRIPTION OF THE INVENTION

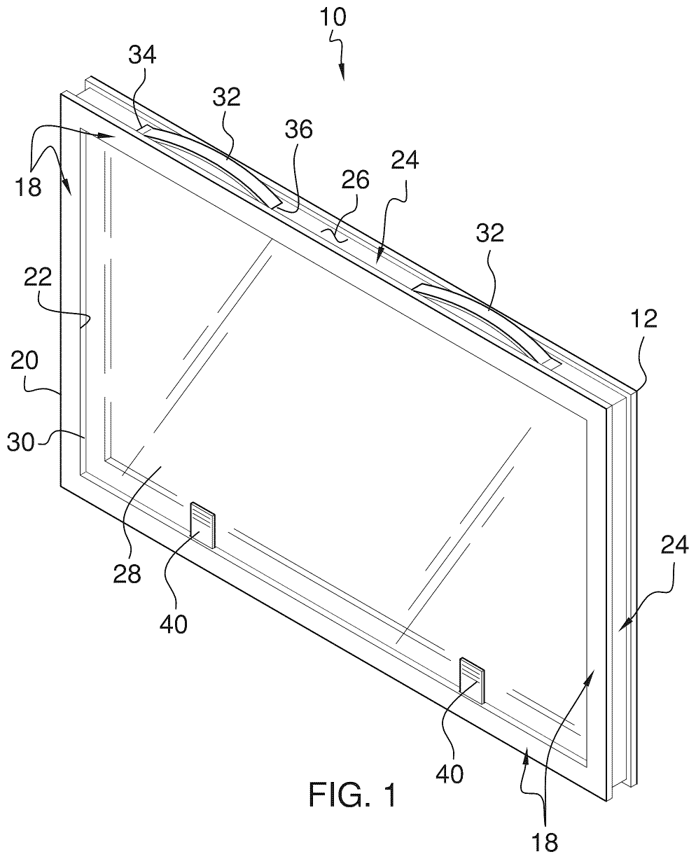

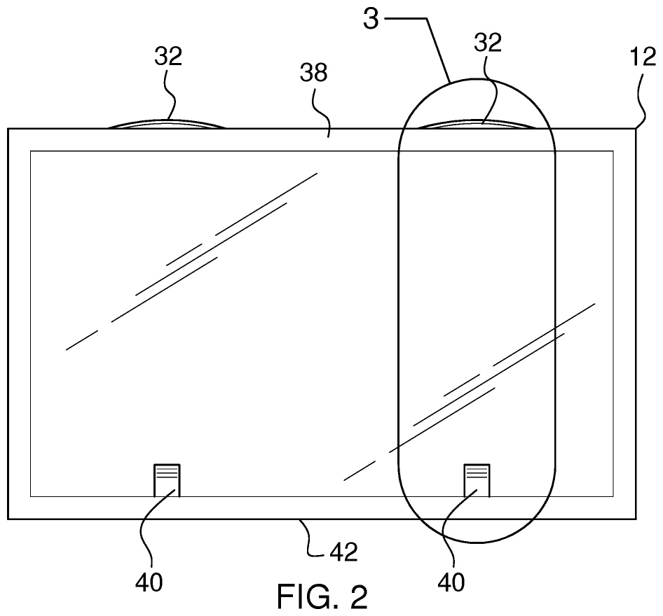

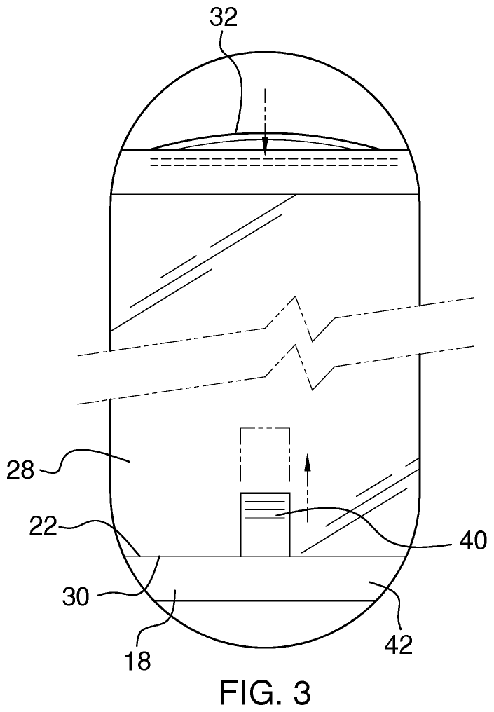

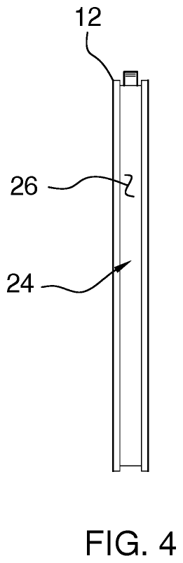

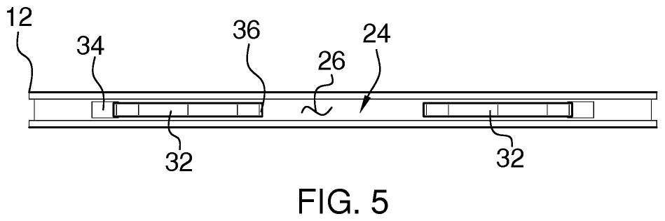

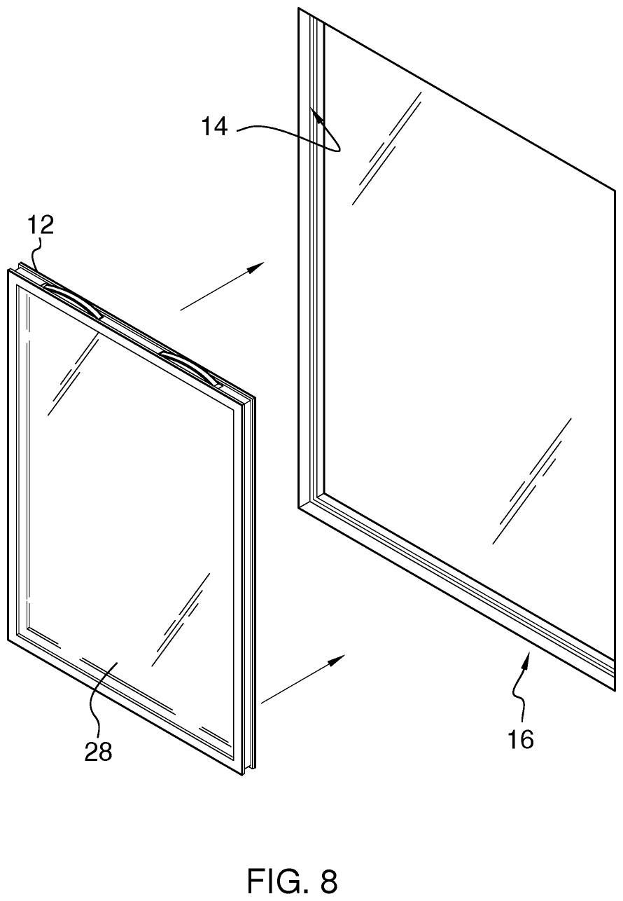

With reference now to the drawings, and in particular to FIGS. 1 through 8 thereof, a new window panel device embodying the principles and concepts of an embodiment of the disclosure and generally designated by the reference numeral 10 will be described.

As best illustrated in FIGS. 1 through 8, the removable window panel device 10 generally comprises a surround 12 that is structured to have dimensions which conform to a window screen opening 14 in a window frame 16. The window frame 16 may be installed in an exterior wall of a house, for example, and the window frame 16 may be double pane window of any conventional design. The surround 12 comprises a plurality of intersecting members 18 which each has an outwardly facing side 20 and an inwardly facing side 22. The each of the plurality of intersecting members 18 has a channel 24 that is recessed into the outwardly facing side 20 thereby facilitating the channel 24 to insertably receive structural elements of the window frame 16. Furthermore, the channel 24 associated with each of the intersecting members 18 extends along a full length of the intersecting members 18 such that the channel 24 associated with each of the intersecting members 18 intersects one another. The channel 24 associated with each of the plurality of intersecting members 18 has a lower bounding surface 26.

A windowpane 28 is integrated into the surround 12 and the windowpane 28 is comprised of a transparent material, including but not being limited to glass or plastic, to pass light through the windowpane 28. Additionally, the windowpane 28 is comprised of a fluid impermeable material, including but not being limited to glass or plastic, to inhibit wind from passing through the windowpane 28. The windowpane 28 has a perimeter edge 30 that is attached to the inwardly facing side 22 of each of the plurality of intersecting members 18 of the surround 12 such that the windowpane 28 closes an opening defined by the surround 12.

A pair of tension springs 32 is provided and each of the tension springs 32 is attached to the surround 12. Each of the tension springs 32 is compressible to lie flat against the surround 12 when the surround 12 is inserted into the window screen opening 14 in the window frame 16 to facilitate the surround 12 to be fully seated in the window screen opening 14. Furthermore, each of the pair of tension springs 32 is biased to curve upwardly from the surround 12 thereby facilitating the tension springs 32 to retain the surround 12 in the window screen opening 14. Each of the tension springs 32 has a coupled end 34 and a free end 36 and the coupled end 34 of each of the tension springs 32 is coupled to the lower bounding surface 26 of the channel 24 in a topmost one of the plurality of intersecting members 38 of the surround 12. The free end 36 of each of the tension springs 32 rests against the lower bounding surface 26 of the channel 24 in which the tension springs 32 are positioned. Each of the tension springs 32 is curved between the coupled end 34 and the free end 36 such that each of the tension springs 32 forms an arc on the lower bounding surface 26 of the channel 24 in which the tension springs 32 are positioned. Additionally, the free end 36 of each of the pair of tension springs 32 is directed toward each other.

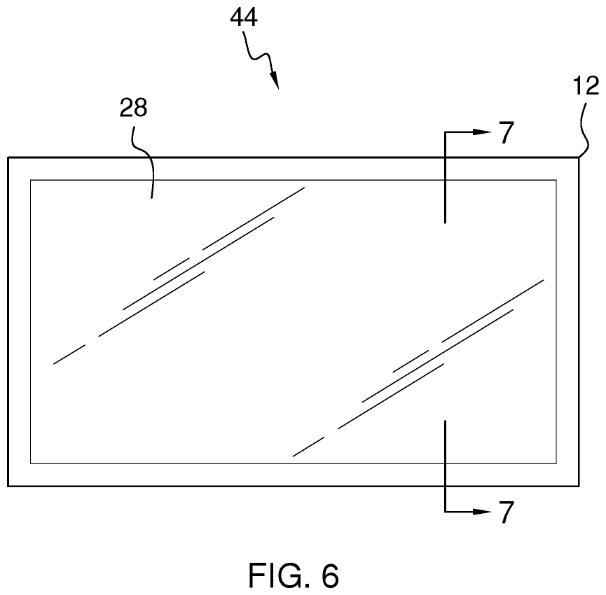

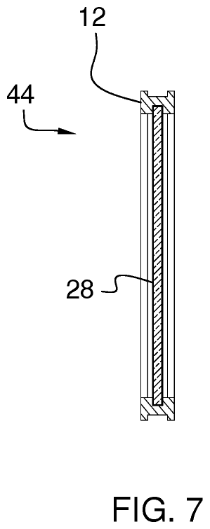

A pair of tabs 40 is provided and each of the tabs 40 is coupled to and extends upwardly from the surround 12. In this way the pair of tabs 40 can be gripped for subsequently urging the surround 12 upwardly in the window screen opening 14 in the window frame 16 to compress the tension springs 32 for fully seating the surround 12 in the window screen opening 14. Each of the tabs 40 extends upwardly from the inwardly facing side 22 of a bottommost one of the plurality of intersecting members 42. Additionally, each of the tabs 40 is positioned between the windowpane 28 and a front side 44 of the bottommost intersecting member 42. In an alternative embodiment 44 shown in FIGS. 6 and 7, the tabs 40 and the tension springs 32 are absent from the casement to facilitate a variety of different attachment means.

In use, the existing window screen in a window frame 16 is removed from the window screen opening 14 and the windowpane 28 and surround 12 are installed into the window screen opening 14. In this way the windowpane 28 inhibits wind from passing through the window screen opening 14 when the window frame 16 is opened. Thus, the windowpane 28 enhances the thermal efficiency of the window frame 16. As is shown in the alternative embodiment 44, the windowpane 28 and the surround 12 can be attached to the window frame 16 with fasteners, for example, when the window frame 16 does not have a window screen opening 14. In this way the windowpane 28 and the surround 12 can be retrofitted onto any existing window frame 16 for enhancing the thermal efficiency of the existing window frame 16.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A removable window panel device for replacing a window screen, said device comprising:
a surround configured to be positioned in a window frame replacing a window screen removed from the window frame;
a panel being integrated into said surround, said panel being comprised of a clear plastic material wherein said panel is configured to pass light through said panel, said panel being comprised of a fluid impermeable material wherein said panel is configured to inhibit wind from passing through said panel;
a pair of tension springs, each of said tension springs being attached to said surround, each of said tension springs being compressible to lie flat against said surround when said surround is inserted into a window screen opening in said window frame to facilitate said surround to be fully seated in said window screen opening, each of said pair of tension springs being biased to curve upwardly from said surround thereby facilitating said tension springs to retain said surround in said window screen opening;
a pair of tabs, each of said tabs being coupled to and extending upwardly from said surround thereby facilitating said pair of tabs to be gripped for subsequently urging said surround upwardly in said window screen opening in said window to compress said tension springs to facilitate said surround to be fully seated in said window screen opening.

2. The device according to claim 1, wherein:
said surround comprises a plurality of intersecting members which each has an outwardly facing side and an inwardly facing side;
said each of said plurality of intersecting members has a channel being recessed into said outwardly facing side thereby facilitating said channel;
said channel of each of said intersecting members extends along a full length of said intersecting member such that said channel associated with each of said intersecting members intersects one another; and
said panel has a perimeter edge being attached to said inwardly facing side of each of said plurality of intersecting members of said surround such that said panel closes an opening defined by said surround.

3. The device according to claim 2, wherein:
said channel associated with each of said plurality of intersecting members has a lower bounding surface;
each of said tension springs has a coupled end and a free end, said coupled end of each of said tension springs being coupled to said lower bounding surface of said channel in a topmost one of said plurality of intersecting members of said surround;
said free end of each of said tension springs rests against said lower bounding surface of said channel in which said tension springs are positioned;
each of said tension springs is curved between said coupled end and said free end such that each of said tension springs forms an are on said lower bounding surface of said channel in which said tension springs are positioned; and
said free end of each of said pair of tension springs being directed toward each other.

4. The device according to claim 1, wherein:
each of said tabs extends upwardly from an inwardly facing side of a bottommost one of said plurality of intersecting members; and
each of said tabs is positioned between said windowpane and a front side of said bottommost intersecting member.

5. A removable window panel device for replacing a window screen, said device comprising:
a surround configured to be positioned in a window frame replacing a window screen removed from the window frame, said surround comprising a plurality of intersecting members which each has an outwardly facing side and an inwardly facing side, said each of said plurality of intersecting members having a channel being recessed into said outwardly facing side, said channel associated with each of said intersecting members extending along a full length of said intersecting member such that said channel associated with each of said intersecting members intersects one another, said channel associated with each of said plurality of intersecting members having a lower bounding surface;
a panel being integrated into said surround, said panel being comprised of a clear plastic material wherein said panel is configured to pass light through said panel, said panel being comprised of a fluid impermeable material wherein said panel is configured to inhibit wind from passing through said panel, said panel having a perimeter edge being attached to said inwardly facing side of each of said plurality of intersecting members of said surround such that said panel closes an opening defined by said surround;
a pair of tension springs, each of said tension springs being attached to said surround, each of said tension springs being compressible to lie flat against said surround when said surround is inserted into said window screen opening in said window frame to facilitate said surround to be fully seated in said window screen opening, each of said pair of tension springs being biased to curve upwardly from said surround thereby facilitating said tension springs to retain said surround in said window screen opening, each of said tension springs having a coupled end and a free end, said coupled end of each of said tension springs being coupled to said lower bounding surface of said channel in a topmost one of said plurality of intersecting members of said surround, said free end of each of said tension springs resting against said lower bounding surface of said channel in which said tension springs are positioned, each of said tension springs being curved between said coupled end and said free end such that each of said tension springs forms an arc on said lower bounding surface of said channel in which said tension springs are positioned, said free end of each of said pair of tension springs being directed toward each other; and
a pair of tabs, each of said tabs being coupled to and extending upwardly from said surround thereby facilitating said pair of tabs to be gripped for subsequently urging said surround upwardly in said window screen opening in said window to compress said tension springs to facilitate said surround to be fully seated in said window screen opening, each of said tabs extending upwardly from said inwardly facing side of a bottommost one of said plurality of intersecting members, each of said tabs being positioned between said panel and a front side of said bottommost intersecting member.

6. (canceled)
